(19) United States
(12) Patent Application Publication
(10) Pub. No.: US 2012/0267280 A1
(43) Pub. Date: Oct. 25, 2012

(54) VESSEL FOR MOLTEN SEMICONDUCTING MATERIALS AND METHODS OF MAKING THE SAME

(76) Inventors: Glen Bennett Cook, Elmira, NY (US); Kenneth Edward Hrdina, Horseheads, NY (US); Christopher Scott Thomas, Horseheads, NY (US); John Forrest Wight, JR., Corning, NY (US)

(21) Appl. No.: 13/093,336

(22) Filed: Apr. 25, 2011

(51) Int. Cl. B65D 85/00; B29C 39/12

(52) U.S. Cl. 206/524.1; 264/255

(57) ABSTRACT

The disclosure relates to vessels configured to contain molten semiconducting materials. The vessels include a high purity fused silica lining having a base and sidewalls that define an interior volume, and a fused silica backing proximate the external surfaces of the lining

### FIELD OF THE INVENTION

The disclosure relates generally to vessels configured to contain molten semiconducting materials, and more particularly to vessels comprising a dense, high-purity lining and a porous, insulating backing that can support the lining Embodiments of the disclosure also relate to methods of making such vessels.

### BACKGROUND

Semiconducting materials are used in a variety of applications, and may be incorporated, for example, into electronic devices such as photovoltaic devices. Photovoltaic devices convert light radiation into electrical energy through the photovoltaic effect.

The properties of semiconducting materials may depend on a variety of factors, including crystal structure, the concentration and type of intrinsic defects, and the presence and distribution of dopants and other impurities. Within a semiconducting material, the grain size and grain size distribution, for example, can impact the performance of resulting devices. By way of example, the electrical conductivity and thus the overall efficiency of a semiconductor-based device such as a photovoltaic cell will generally improve with larger and more uniform grains.

For silicon-based devices, silicon may be formed using a variety of techniques. Examples include silicon formed as an ingot, sheet or ribbon. The silicon may be supported or unsupported by an underlying substrate.

Unsupported single crystalline semiconducting materials can be produced, for example, using Czochralski or Bridgman processes. However, such bulk methods may disadvantageously result in significant kerf loss when the material is cut into thin sheets or wafers. Additional methods by which unsupported polycrystalline semiconducting materials can be produced include electromagnetic casting and direct net-shape sheet growth methods such as ribbon growth processes. However, these techniques tend to be slow and expensive. Polycrystalline silicon ribbon produced using silicon ribbon growth technologies is typically formed at a rate of only about 1-2 cm/min.

Supported semiconducting material sheets may be produced less expensively, but the semiconducting material sheet may be limited by the substrate on which it is formed, and the substrate may have to meet various process and application requirements, which may be conflicting.

Methods for producing polycrystalline semiconducting materials are disclosed in commonly-owned U.S. patent application Ser. Nos. 12/466,143 and 12/394,608, the disclosures of which are hereby incorporated by reference. These disclosures relate generally to exocasting methods for forming polycrystalline semiconducting materials wherein a solid layer of semiconducting material is formed over an external surface of a mold that is submersed into a molten semiconducting material. The molten semiconducting material is typically contained within a refractory vessel.

In various applications, the vessel can be mechanically and chemically stable at elevated temperatures, thermally insulating, and have a high purity, particularly at the inner surfaces that contact the molten semiconducting material. In some processes, the molten semiconducting material can be heated to temperatures in excess of 1400° C.

Disclosed herein are vessels capable of containing molten semiconducting materials. The vessels may be characterized, for example, by their temperature stability, purity, and/or thermal insulating properties. It will be appreciated, however, that the temperature stability, purity, and/or thermal insulating properties in respective embodiments may be present to a greater or lesser extent, or may not be present at all. Each of the disclosed embodiments is intended to be within the scope of the disclosure.

### SUMMARY

A vessel configured to contain a molten semiconducting material includes a lining comprising a first fused silica, said lining having a base and sidewalls defining an interior volume, and a porous backing comprising a second fused silica proximate to external surfaces of the lining. The lining comprises a high purity material and has a total impurity content of 100 ppbw or less. In embodiments, the fused silica incorporated into the backing is less dense (e.g., has a higher porosity) than the fused silica incorporated into the lining.

The disclosure relates also to methods of making such a vessel. In an example method, a vessel can be made by forming a lining comprising a first fused silica, where the lining has a base and sidewalls that define an interior volume. A backing comprising a second fused silica can be formed proximate to the external surfaces of the lining and can support the lining. In the disclosed method, the lining has a total impurity content of 100 ppbw or less and is more dense (e.g., less porous) than the backing.

Additional objects and advantages of the disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the claims. The accompanying drawings, which are incorporated in and constitute a part of this specification, illustrate exemplary embodiments of the disclosure and, together with the description, serve to explain the principles described herein.

### BRIEF DESCRIPTION OF THE DRAWINGS

FIG. 1 is a perspective view of a vessel according to one exemplary embodiment;

FIG. 2 is a side view of a vessel according to a further exemplary embodiment;

FIG. 3 is a cross-sectional view of the vessel along line 3-3 of FIG. 2;

FIG. 4 is a side view of a vessel according to a further exemplary embodiment; and

FIG. 5 is a side view of a vessel having a sub-lining according to one embodiment.

### DETAILED DESCRIPTION

A vessel is configured to contain a molten semiconducting material, such as molten silicon, and can be used to enable heating of the molten semiconducting material while it is contained within the vessel. The vessel comprises a lining of a first fused silica material, and a backing of a second fused silica material proximate to external surfaces of the lining. The lining has a base and sidewalls that define an interior volume adapted to contain the molten semiconducting material, and comprises a dense, high purity material that has a total impurity content of 100 ppbw or less and a total porosity less than a porosity of the backing.

As used herein, the term “semiconducting material” includes any material that exhibits semiconducting properties, such as, for example, silicon, germanium, gallium arsenide, as well as alloys and mixtures thereof.

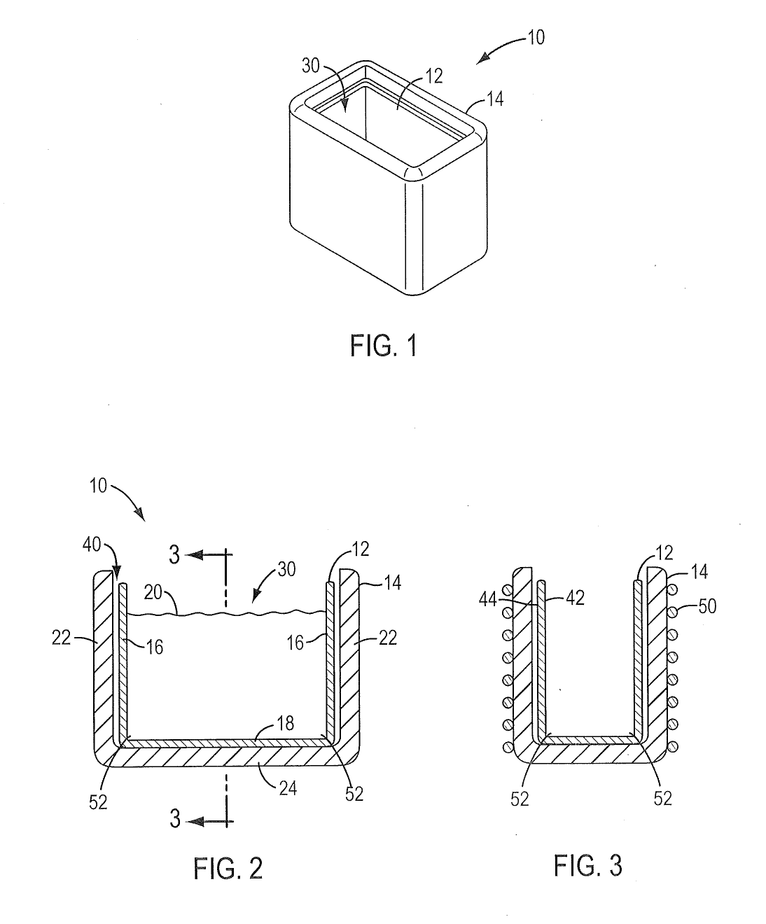

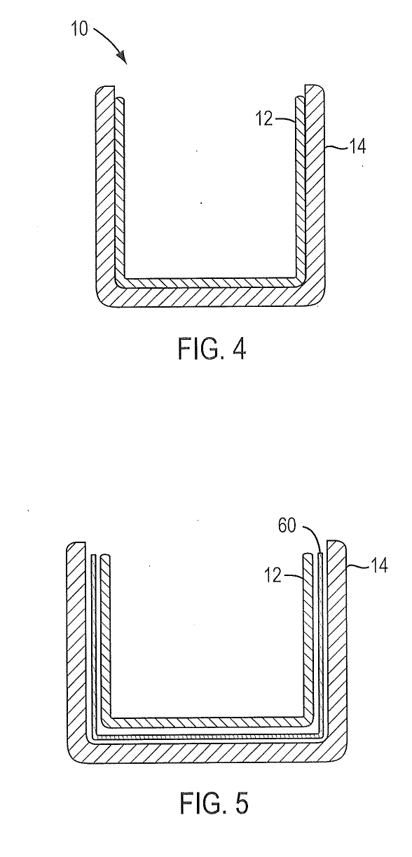

FIG. 1 is a perspective view of a vessel 10 according to an exemplary embodiment. FIG. 2 is a side view of a vessel 10, and FIG. 3 is a cross-sectional side view of the vessel 10 along line 3-3 of FIG. 2. By way of example, the vessel 10 may be a crucible capable of containing, for example, molten silicon heated to about 1450° C. In various embodiments, the vessel may provide thermal insulation with respect to the molten semiconducting material, which can facilitate the efficient incorporation of energy used to form and maintain the melt.

As seen in FIG. 2, the vessel 10 includes a lining 12 and a backing 14 proximate the external surfaces of the lining 12. The lining 12 includes sidewalls 16 and a base 18 that cooperate to define an interior volume 30. The interior volume 30 is capable of containing molten semiconducting material 20 where an inner surface of the lining 12 is in direct physical contact with the molten semiconducting material 20.

The lining may be formed from a unitary part, or may be formed from separate parts that are affixed to one another. As an example, the sidewalls 16 may comprise a single segment or a plurality of straight or curved segments that are attached to one another to define a three-dimensional structure. In further embodiments, the sidewalls 16 may define a three-dimensional shape having a square, rectangular, circular or oval cross-section. A base 18 may be affixed to the sidewalls to form the lining 12.

The lining 12 can be formed from a high purity, dense material, which enables its direct contact with the molten semiconducting material. In various embodiments, the lining 12 is formed from high purity fused silica. By forming the lining 12 from fused silica having a low total impurity content, the incorporation of impurities into the molten semiconducting material can be minimized.

In embodiments, the total impurity content of the lining 12 may be 100 parts per billion by weight (ppbw) or less. In other embodiments, the total impurity content of the lining 12 may be less than 50 ppbw.

With respect to different potential impurities, the fused silica used to form the lining can, independently or in any combination, have a maximum total concentration of 30 ppbw of alkali metals, 10 ppbw of alkaline earth metals, 1 ppbw of ferrous metals, 0.05 ppbw of refractory metals, 0.05 ppbw of noble metals, and 0.05 ppbw of rare earth metals.

Alkali metals include lithium, sodium, potassium, rubidium and cesium. Alkaline earth metals include magnesium, calcium, strontium and barium. Refractory metals may include titanium, vanadium, zirconium, niobium, molybdenum, hafnium, tantalum, tungsten and rhenium. Ferrous metals include chromium, manganese, iron and cobalt. Noble metals include ruthenium, rhodium, palladium, silver, osmium, iridium, platinum and gold. Rare earth metals include scandium, yttrium, lanthanum, cerium, praseodymium, neodymium, samarium, europium, gadolinium, terbium, dysprosium, holmium, erbium, thulium, ytterbium and lutetium.

The lining 12 may comprise at least one of alumina and boron oxide. Alumina and/or boron oxide may be added to the lining to create traps for impurities such as alkali metals, and thus inhibit the diffusion of such impurities from the lining into the molten semiconducting material. Alumina and boron oxide may be incorporated into the fused silica of the lining 12 at respective concentrations of 0-100 ppbw of atomic aluminum or atomic boron.

The lining material may include about 1000 parts per million by weight (ppmw) or less of water. The presence of water may reduce the viscosity of the fused silica, which may allow the lining 12 to flow or creep during heating of the molten semiconducting material 20. The viscosity of the lining can be greater than 10⁸ poise at 1400° C. In embodiments, the lining can comprise a fused silica having a strain point of at least 850° C., an anneal point of at least 1000° C., and a softening point of at least 1490° C.

In embodiments, the lining comprises dense or substantially dense fused silica. The lining may have a total porosity of less than 5 vol. % (e.g., less than 5, 2.5, 1, 0.5 or 0.1 vol. % porosity). The low porosity may result in a lining having a relatively smooth inner surface 42. A smooth inner surface will present a lower surface area of liner material to the molten semiconducting material 104 than a rough inner surface 42, which can limit the number of impurities that diffuse from the lining into the molten semiconducting material. A dense, low porosity lining may also act as a diffusion barrier to inhibit or prevent impurities from diffusing from the backing 14 into the molten semiconducting metal. In embodiments, an inner surface 42 of the lining 12 may have a root mean square (RMS) roughness of less than about 100 nm over an area of 500×500 microns (e.g., less than 100, 50, 25, 10, 2.5, 1, 0.5 or 0.1 nm).

In further embodiments, the outer surface 44 of the lining 12 may have a surface roughness greater than the surface roughness of the inner surface. A greater roughness at the outer surface may improve the insulation properties of the lining.

The inner surface 42 of the lining may be substantially free of inclusions. An inclusion level within a near surface region (e.g., at a depth 0-2 mm from the inner surface of the lining) may be less than 2 inclusions/cm³ (e.g., less than 2, 1 or 0.5 inclusions/cm³). According to a further embodiment, any inclusions found in the lining can have a maximum size of 500 μm. (e.g., a maximum size of up to 100, 200, 300, 400 or 500 μm).

In various embodiments, the sidewalls 16 of the lining 12 may have a thickness ranging from about 1 mm to about 8 mm. For example, the sidewalls 16 may have a thickness ranging from about 2 mm to about 5 mm. Lining sidewalls having a thickness of at least 1 mm can provide sufficient structural integrity to support the molten semiconducting material 20, and may also provide sufficient material to accommodate some material loss due to corrosion of the sidewalls 16 through exposure to the molten semiconducting material. On the other hand, by limiting the thickness of the lining sidewalls to 8 mm, efficient energy coupling between an external heating element and the molten semiconducting material can be maintained. The base of the lining may have a thickness ranging from about 1 mm to about 8 mm (e.g.,. from about 2 to 5 mm).

In various embodiments, the sidewalls 16 and the base 18 of the lining 12 intersect at a rounded edge. In embodiments where, for example, a radio-frequency energy source is used to heat the molten semiconducting material, it can be advantageous to minimize the presence of sharp edges or square corners within the vessel. By way of example, the sidewalls and the base of the lining can intersect to form a rounded inner edge 52 having a radius of curvature of at least about 2 mm (e.g., from 2 to 5 mm).

The lining 12 has an outer surface 44 that faces a backing 14, which is situated proximate the lining 12, and may be either in direct contact with the lining 12 or may be separated from the lining by a gap. Portions of the lining may be separated from the backing via a gap, while portions of the lining may be in direct physical contact with the backing.

The backing 14 may comprise a unitary part, or may be formed from a plurality of separate sidewall segments 22. For example, as shown in FIG. 2, the backing 14 may comprise a plurality of segments 22 affixed to one another and configured to laterally enclose the lining. The backing 14 also comprises a base 24 to which the sidewalls 22 are optionally affixed.

The backing 14 may comprise a material having minimal impurities in order to minimize impurity transfer to the molten semiconducting material 20. In various embodiments, the backing 14 may comprise fused silica. However, because the backing is not in direct contact with the molten semiconducting material, the fused silica of the backing 14 may have an impurity content greater than the impurity content of the fused silica that forms the lining 12. In various embodiments, the total impurity content within the backing 14 may be 10 ppmw or less, such as, for example, 1 ppmw or less.

The backing 14 may optionally contain alumina or boron oxide. As with the lining 12, alumina and/or boron oxide may be incorporated into the backing to create traps for impurities such as alkali metals, and thus inhibit the diffusion of such impurities from the lining into the molten semiconducting material. Such sinks or traps can minimize diffusion of impurities from the backing 14 into the lining 12.

Alumina may be incorporated into the fused silica of the backing at concentrations of, for example, between 100 ppbw and 20 wt. % of atomic aluminum. Boron oxide may be incorporated into the fused silica of the backing at concentrations of, for example, between 100 ppbw and 1 wt. % of atomic boron. The addition of alumina to the backing may, in at least some exemplary embodiments, be preferable to the addition of boron oxide because boron oxide may undesirably decrease the viscosity of the backing.

In various embodiments, a density of the backing material can be less than a density of the lining material. In a similar vein, a porosity of the backing can be greater than a porosity of the lining. For example, a porosity of the backing can range from 5 to 80 vol. %. (e.g., less than 5, 10, 20, 30, 40, 50, 60, 70 or 80 vol. %). A higher porosity in the backing may, in certain embodiments, more efficiently insulate the lining as well as the molten semiconducting material contained therein during heating of the molten semiconducting material.

In order to heat the molten semiconducting material and maintain the molten semiconducting material in a molten state, a heating element 50, such as an RF induction coil, may be positioned proximate to external surfaces of the backing 14. Without wishing to be bound by theory, to promote efficient coupling of RF energy into the molten semiconducting material, the RF coil should be located as close to the molten semiconducting material as possible. Thus, is may be desirable to minimize the total thickness of the vessel, including the respective thicknesses of the lining and backing sidewalls.

In various embodiments, the sidewalls 22 of the backing 14 may have a thickness of about 20 mm or less. The combined thickness of the sidewalls 16 of the lining 12 and the sidewalls 22 of the backing 14 may, in certain embodiments, be about 20 mm or less, so that energy from the heating element 50 can be efficiently coupled to the molten semiconducting material 20 within the vessel 10.

As shown in FIGS. 2 and 3, a physical gap 40 may be defined between an external surface of the lining 12 and an internal surface of the backing 14. The gap may have a width ranging from about 0 mm to 3 mm. The gap width may be constant or, in some embodiments, the gap width may vary with location. A measurable gap between the external surfaces of the lining and the internal surfaces of the backing assures that in some embodiments the lining can be inserted into the backing. When assembled, the external surfaces of the lining can be substantially parallel to respective internal surfaces of the backing. In the assembled vessel the base of the lining can be in physical contact with the base of the backing (e.g., without an appreciable gap).

During use of the vessel, when a molten semiconducting material 20 is disposed therein, the gap width between sidewalls (e.g., outer sidewalls of the lining and inner sidewalls of the backing) may decrease or increase at particular locations between an external surface of the lining 12 and an internal surface of the backing 14 due to deformation or creep of the fused silica materials.

In various exemplary embodiments, as illustrated for example in FIG. 5, one or more intermediate linings 60 may optionally be incorporated between the lining 12 and the backing 14. If used, the intermediate linings 60 may minimize impurities in and/or provide thermal insulation for the molten semiconducting material 20. An intermediate lining 60 may comprise fused silica and may or may not be in physical contact with one or both of the lining 12 and the backing 14.

Further embodiments of the disclosure relate to methods for making the disclosed vessels. Vessel 10 can be formed by disposing a backing 14 proximate to external surfaces of a lining. The lining can be formed, for example, by assembling previously formed lining segments (e.g., a tubular sidewall and a base). The backing can be formed, for example, by slip casting a unitary part or by assembling previously formed (e.g., slip cast) backing segments into a desired shape that is configured to contain the lining.

Both the lining and the backing can, independently of one another, be formed as unitary parts. In embodiments where the lining and/or backing are formed as a unitary part, they can be formed, for example, by milling or water jetting a solid piece of material (e.g., fused silica) used to form the respective part.

In one example method, a lining 14 and a backing 16 can be assembled separately and then brought into registry with one another. For example, a preassembled lining can be slideably engaged within a preassembled backing. In a further example method, a lining 14 can be assembled, and then the backing 16 can be assembled during the process of positioning the backing proximate to external surfaces of the lining For instance, the backing 16 can comprise a plurality of backing segments that are assembled together as they are brought into registry with external surfaces of the lining Optionally, a gap may be defined at interfaces between the lining and the backing.

In alterative methods, the lining and the backing can each be assembled from two or more respective segments. Segments used to form a lining or a backing can be brought together and joined, for example, by heating the segments globally or locally (e.g., where the segments intersect) to fuse the segments together. Segments may be fused together by any method known, such as, for example, by holding the segments together and heating at least a part of the segments to a suitable temperature for a suitable time.

The fusion bonding of separate segments can depend on temperature, time, the force applied to the segments being joined, and the purity and surface finish of the interfaces to be joined. A fusion bonding temperature can range from 500° C. to 1550° C. (e.g., 500, 750, 1000, 1250, 1500 or 1550° C.), and a fusion bonding time can range from 1 second to 1 week. The fusion bonding temperature should be sufficiently high to form a fusion bond, but not so high as to cause undesired deformation or sagging of the heated part.

In embodiments, the interfaces to be joined can be polished in order to promote a fusion bond that does not allow any leakage of the molten semiconducting material. By providing pristine surfaces, incomplete or ineffective fusion bonding (such as interfaces comprising air pockets or sections of unbonded material) can be avoided. While polishing the surfaces to be joined may not be required in all embodiments, polishing may, in at least certain embodiments, reduce the temperature needed to affix one piece to another.

Prior to or after assembly, but before use, the lining and/or backing can be cleaned such as by acid etching to remove debris or other surface contamination. In embodiments, if the lining or backing are acid etched prior to fusion bonding separate segments, a protective coating such as a polymer layer, can be formed over the surfaces to be joined in order to protect these surfaces from the acid etch.

It is to be noted that, unless otherwise stated, the methods disclosed herein are not to be construed as consequent steps in a routine, but merely as inclusive of the recited operations in any order as would be known to one of skill in the art. Certain disclosed steps may also optionally be omitted, or unrecited steps added, and still be within the scope of the disclosure.

Unless otherwise indicated, all numbers used in the specification and claims are to be understood as being modified in all instances by the term “about,” whether or not so stated. It should also be understood that the precise numerical values used in the specification and claims form additional embodiments of the invention.

As used herein the use of “the,” “a,” or “an” means “at least one,” and should not be limited to “only one” unless explicitly indicated to the contrary. Thus, for example, the use of “the side” or “side” is intended to mean at least one side.

It is also noted that recitations herein refer to a component of the present invention being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

It will be apparent to those skilled in the art that various modifications and variations can be made to the present invention without departing from the spirit and scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

Other embodiments of the invention will be apparent to those skilled in the art from consideration of the specification and practice of the invention disclosed herein. It is intended that the specification and examples be considered as exemplary only, with a true scope and spirit of the invention being indicated by the claims.

What is claimed is:

1. A vessel configured to contain a molten semiconducting material, the vessel comprising:
a lining comprising a first fused silica, said lining having a base and sidewalls defining an interior volume; and
a backing comprising a second fused silica proximate to external surfaces of the lining, wherein
the lining has a total impurity content of 100 ppbw or less, and
a porosity of the first fused silica is less than a porosity of the second fused silica.

2. The vessel according to claim 1, wherein the first fused silica has an impurity content of 30 ppbw or less of alkali metals, 10 ppbw or less of alkaline earth metals, 1 ppbw or less of ferrous metals, 0.05 ppbw or less of refractory metals, 0.05 ppbw or less of noble metals, and 0.05 ppbw or less of rare earth metals.

3. The vessel according to claim 1, wherein the first fused silica comprises 1000 ppm of water or less.

4. The vessel according to claim 1, wherein the lining further comprises at least one impurity selected from the group consisting of alumina and boron oxide.

5. The vessel according to claim 1, wherein a total impurity content of the first fused silica is less than a total impurity content of the second fused silica.

6. The vessel according to claim 1, wherein the first fused silica has a total porosity of 5 vol. % or less.

7. The vessel according to claim 1, wherein the second fused silica has a total porosity of 80 vol. % or less.

8. The vessel according to claim 1, wherein an inner surface of the lining has an RMS surface roughness of less than 100 nm.

9. The vessel according to claim 1, wherein an outer surface of the lining has an RMS surface roughness of greater than 1 nm.

10. The vessel according to claim 1, wherein the lining sidewalls have an inclusion density of less than 2 inclusions/cm³.

11. The vessel according to claim 1, wherein the lining sidewalls have a thickness ranging from 1 mm to 8 mm.

12. The vessel according to claim 1, wherein the backing has a side wall having a thickness of 20 mm or less.

13. The vessel according to claim 1, wherein an outer surface of the lining is in intimate physical contact with an inner surface of the backing.

14. The vessel according to claim 1, wherein an outer surface of the lining is in intimate physical contact with an inner surface of the backing and a total thickness of a sidewall of the vessel is 20 mm or less.

15. The vessel according to claim 1, wherein an outer surface of the lining and an inner surface of the backing define a gap therebetween.

16. The vessel according to claim 1, wherein the lining comprises a first sub-layer and a second sub-layer located between the first sub-layer and the backing.

17. The vessel according to claim 1, wherein the base of the lining and the sidewalls of the lining intersect at a corner having a radius of curvature of at least 2 mm.

18. The vessel according to claim 1, wherein the lining is configured to inhibit diffusion of impurities from the backing into a molten semiconducting material contained within the interior volume.

19. The vessel according to claim 1, wherein the backing is configured to thermally insulate the lining and a molten semiconducting material contained within the interior volume.

20. A method of making a vessel configured to contain a molten semiconducting material, the method comprising:
forming a lining comprising a first article of fused silica, said lining having a base and sidewalls defining an interior volume; and
forming a backing comprising a second article of fused silica proximate to external surfaces of the lining, wherein
the lining has a total impurity content of 100 ppbw or less, and
a porosity of the first fused silica is less than a porosity of the second fused silica.
